(19) United States
(12) Patent Application Publication
(10) Pub. No.: US 2016/0274698 A1
(43) Pub. Date: Sep. 22, 2016

(54) SENSOR PANEL AND METHOD OF MANUFACTURING SENSOR PANEL

(71) Applicant: ALPS ELECTRIC CO., LTD., Tokyo (JP)

(72) Inventors: Takayuki ITO, Miyagi-ken (JP); Ayumu ANZAI, Miyagi-ken (JP); Shinichi HIGUCHI, Miyagi-ken (JP)

(21) Appl. No.: 15/064,261

(22) Filed: Mar. 8, 2016

(30) Foreign Application Priority Data
Mar. 17, 2015 (JP) 2015-053520

(51) Int. Cl. G06F 3/044; B29C 45/16

(52) U.S. Cl. CPC G06F 3/044; B29C 45/1671; B29K 2069/00

(57) ABSTRACT

Provided is a sensor panel including a transparent electrode layer formed on a transparent substrate, a wiring layer formed in the vicinity of the transparent electrode layer, on the substrate, an opaque decorative layer facing the wiring layer, and a cover layer located between the substrate and the decorative layer. The cover layer is configured such that an operation region corresponding to at least the transparent electrode layer is transparent, and a shielding layer configured to shield an optical path leading to the wiring layer is provided between the wiring layer and the decorative layer.

### CLAIM OF PRIORITY

This application claims benefit of Japanese Patent Application No. 2015-053520 filed on Mar. 17, 2015, which is hereby incorporated by reference.

### BACKGROUND OF THE INVENTION

1. Field of the Invention

The present invention relates to a sensor panel in which a decorative region located outside of an operation region is made narrower, and a method of manufacturing such a sensor panel.

2. Description of the Related Art

A transparent electrode for capacitance detection is disposed in an operation region of a sensor panel, a wiring portion which is connected to the transparent electrode is formed in a frame-like decorative region called a bezel located outside of the operation region, and a decorative layer is formed above the wiring portion so as to cover the wiring portion. When the area of the decorative region increases, a reduction in the width of the operation region is caused. Therefore, an input device disclosed in Japanese Patent No. 5520162 has a configuration in which, in order to reduce the area of a decorative region, a transparent pad portion for connecting a wiring portion and a transparent electrode through lamination therebetween is provided, and a boundary between the operation region and the decorative region is located on this transparent pad portion.

In an operation of a sensor panel, there is such a situation as that in which a user's eyes are obliquely directed to the wiring portion side from the operation region side of the panel surface. In such a situation, in the sensor panel of the related art, there is a problem in that designability is damaged due to a colored wiring portion which is present below the decorative layer being visually recognized. This problem has a tendency to appear more conspicuously as the width of the decorative region is made smaller.

Regarding such a problem, in order for the wiring portion not to be visually recognized from the operation region side, the wiring portion is required to be arranged at a deep position far away from the operation region. However, it is difficult to perform such an arrangement when a reduction in the width of the decorative region is required.

### SUMMARY OF THE INVENTION

Consequently, the present invention provides a sensor panel in which a colored wiring portion (wiring layer) is not likely to be visually recognized from the operation region side, even in a decorative region having a reduction in width, and which is capable of maintaining fixed designability, and a method of manufacturing the sensor panel.

According to an aspect of the present invention, there is provided a sensor panel including: a transparent electrode layer formed on a transparent substrate; a wiring layer formed in the vicinity of the transparent electrode layer, on the substrate; an opaque decorative layer facing the wiring layer; and a cover layer located between the substrate and the decorative layer. The cover layer is configured such that an operation region corresponding to at least the transparent electrode layer is transparent, and a shielding layer configured to shield an optical path leading to the wiring layer is provided between the wiring layer and the decorative layer.

With such a configuration, even when the wiring layer side located below the decorative layer is viewed obliquely from the operation region side of the panel surface, the wiring layer is hidden by the shielding layer, and thus it is possible to prevent designability from deteriorating due to a colored wiring layer being visible. In addition, even when the decorative region is made narrower, it is possible to secure a region in which the wiring layer is formed, and to prevent the wiring layer from being visually recognized when viewed obliquely from the operation region.

In the sensor panel according to the aspect of the present invention, it is preferable that the shielding layer is an opaque coating layer formed on the wiring layer.

Thereby, it is possible to prevent the wiring layer from being visually recognized from the panel surface by a simple configuration and a manufacturing process.

In the sensor panel according to the aspect of the present invention, it is preferable that the shielding layer is configured such that a peripheral region of the cover layer facing the decorative layer is made opaque.

Thereby, even when the wiring layer side is viewed obliquely from the operation region side of the panel surface, it is possible to reliably hide the wiring layer, and to secure fixed designability.

In the sensor panel of the present invention, it is preferable that the shielding layer has the same color as that of the decorative layer, and is formed of the same material as that of the decorative layer.

Thereby, when the wiring layer side is viewed from the operation region side of the panel surface, it is not likely to discriminate between the decorative layer and shielding layer, and thus it is possible to hide the wiring layer.

According to an aspect of the present invention, there is provided a method of manufacturing a sensor panel, the method including: a step of forming a transparent electrode on a transparent substrate; a step of forming a wiring layer in the vicinity of the transparent electrode layer, on the substrate; a step of forming a shielding layer by printing an opaque coating layer on the wiring layer; a step of forming a cover layer, formed of a transparent resin, which has an opaque decorative layer formed on a portion of its surface; and a step of covering a substrate with the cover layer, the substrate having the transparent electrode, the wiring layer, and the shielding layer provided thereon. The shielding layer faces a lower side of the decorative layer with the cover layer interposed therebetween.

Thereby, it is possible to hide the wiring layer by the coating layer, even when the wiring layer side located below the decorative layer is viewed obliquely from the operation region side of the panel surface, just by adding a simple process.

In addition, even when the decorative region is made narrower, it is possible to secure a region in which the wiring layer is formed, and to prevent the wiring layer from being visually recognized when viewed obliquely from the operation region.

According to another aspect of the present invention, there is provided a method of manufacturing a sensor panel, the method including: a step of forming a transparent electrode on a transparent substrate; a step of forming a wiring layer in the vicinity of the transparent electrode layer, on the substrate; a step of disposing a resin layer having an opaque decorative layer within a mold, and injecting an opaque resin into the mold; a step of laminating an opaque shielding layer on a range corresponding to the decorative layer; a step of injecting a transparent resin into the mold, and forming a light-transmissive layer in an inside range of the shielding layer; and a step of fixing a cover layer constituted by the shielding layer and the light-transmissive layer so as to cover the substrate having the transparent electrode and the wiring layer provided thereon. The light-transmissive layer corresponds to an operation region corresponding to the transparent electrode layer, and has the wiring layer located on a lower side of the decorative layer with the shielding layer interposed therebetween.

Thereby, even when the wiring layer side located below the decorative layer is viewed obliquely from the operation region side of the panel surface, it is possible to hide the wiring layer by the shielding layer. In addition, even when the decorative region is made narrower, it is possible to secure a region in which the wiring layer is formed, and to prevent the wiring layer from being visually recognized when viewed obliquely from the operation region.

In the method of manufacturing a sensor panel according to the aspect of the present invention, it is preferable that the mold includes a common mold, a shielding layer forming mold, and a light-transmissive layer forming mold, and that the method further includes: a step of installing the resin layer in the common mold; a step of forming the shielding layer between the common mold and the shielding layer forming mold; and a step of forming the light-transmissive layer between the common mold and the light-transmissive layer forming mold.

Thereby, it is possible to obtain a visual recognition preventing effect of the wiring layer while suppressing manufacturing costs.

According to the present invention, a colored wiring layer is not likely to be visually recognized from the operation region side, even in a decorative region having a reduction in width, and thus, it is possible to maintain fixed designability.

### BRIEF DESCRIPTION OF THE DRAWINGS

FIG. 1 is a perspective view illustrating a configuration of a sensor panel according to a first embodiment of the present invention;

FIG. 2 is a cross-sectional view of the sensor panel according to the first embodiment in a Z direction, and is a cross-sectional view taken along line II-II of FIG. 1;

FIG. 3 is an enlarged view illustrating a portion III of FIG. 2;

FIG. 4 is a cross-sectional view illustrating a process of forming a cover layer in the first embodiment;

FIG. 5 is a cross-sectional view of a sensor panel according to a second embodiment of the present invention in a Z direction;

FIG. 6 is an enlarged view illustrating a portion VI of FIG. 5;

FIG. 7 is a cross-sectional view illustrating a process of forming a shielding layer in the second embodiment; and

FIG. 8 is a cross-sectional view illustrating a process of forming a light-transmissive layer in the second embodiment.

### DESCRIPTION OF THE PREFERRED EMBODIMENTS

Hereinafter, a sensor panel and a method of manufacturing the sensor panel according to embodiments of the present invention will be described in detail with reference to the accompanying drawings. The sensor panel of the present invention is used in a vehicle touch panel, a portable device or the like, and detects that a user's hand or finger touches or approaches an operation region. In addition, the operation region permits light to be transmitted from the surface to the rear surface.

### First Embodiment

### (1) Configuration of Sensor Panel 10

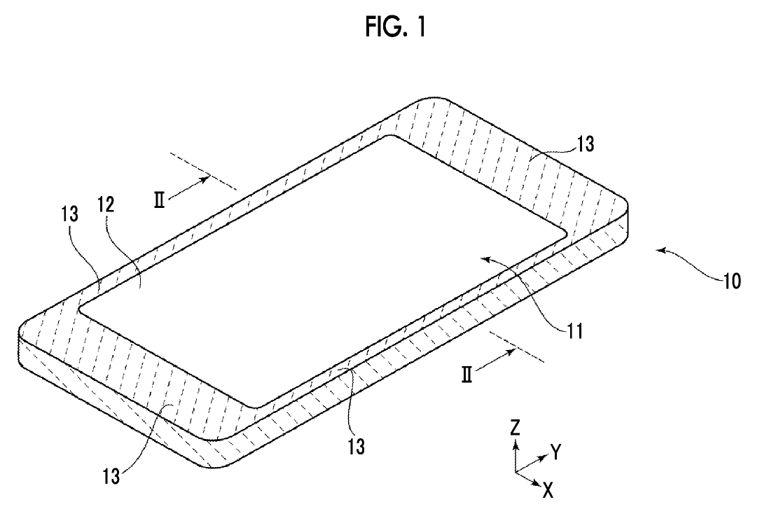

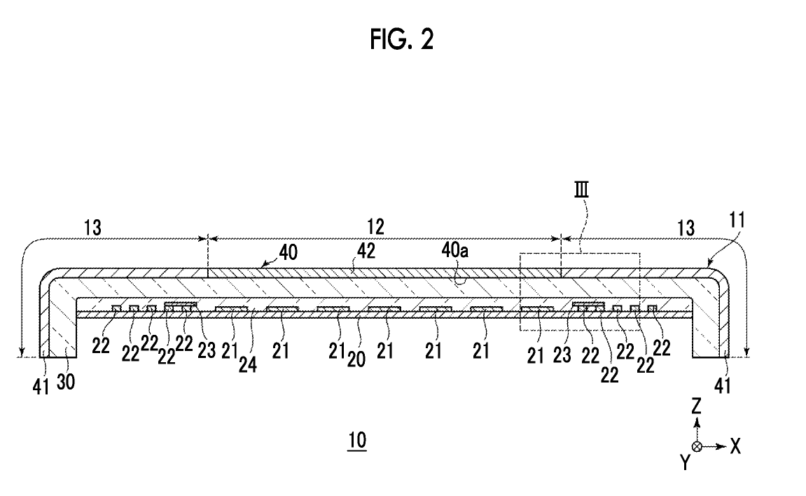

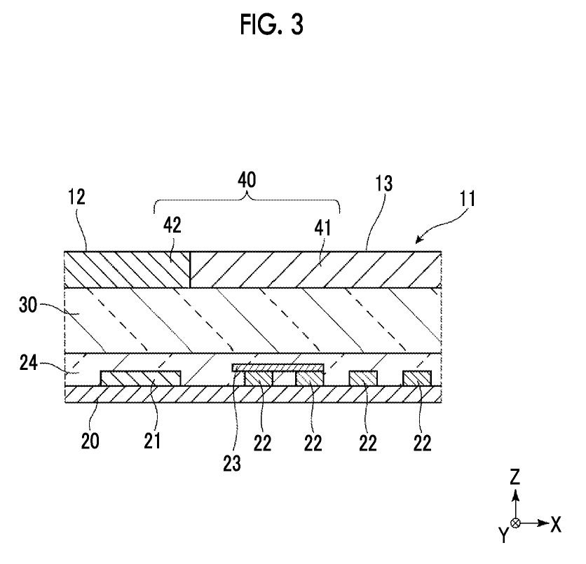

FIG. 1 is a perspective view illustrating a configuration of a sensor panel 10 according to a first embodiment. FIG. 2 is a cross-sectional view of the sensor panel 10 in a Z direction, and is a cross-sectional view taken along line II-II of FIG. 1. FIG. 3 is an enlarged view illustrating a portion III of FIG. 2. In each drawing, X-Y-Z coordinates are shown as reference coordinates. The Z direction is a thickness direction of the sensor panel, and an X direction is a width direction. In addition, an XY plane is orthogonal to the Z direction, and the Z direction may be called an upward direction.

As shown in FIGS. 1 and 2, the sensor panel 10 includes an operation region 12 and a decorative region 13 on a panel surface 11. In addition, as shown in FIG. 2 or 3, the sensor panel 10 includes a substrate 20, a plurality of transparent electrode layers 21, a plurality of wiring layers 22, a coating layer 23 as a shielding layer, an adhesive layer 24, a cover layer 30, and a resin layer 40 constituted by a decorative layer 41 and a light-transmissive layer 42.

The substrate 20 is disposed along the XY plane, and is formed of a light-transmissive material, for example, polyethylene terephthalate (PET), polymethylmethacrylate (PMMA), and other resins or glass.

The plurality of transparent electrode layers 21 are provided on the substrate 20, and is formed of a predetermined pattern by, for example, indium tin oxide (ITO) sputtering, physical vapor deposition (PVD), or chemical vapor deposition (CVD).

The plurality of wiring layers 22 are disposed in regions around the transparent electrode layers 21 on the substrate 20, and are respectively connected to the transparent electrode layers 21 corresponding thereto. It is preferable that the wiring layer 22 is formed by sputtering, for example, copper or an alloy of copper and nickel, and is etched so as to have a predetermined wiring width. In addition, the wiring layer 22 may be configured as a conductive layer having a low-resistance conductor contained in a binder resin, and is formed by applying, for example, silver paste, gold paste, or carbon paste.

The coating layer 23 is formed on the wiring layer 22, as a shielding layer. The coating layer 23 is formed of an opaque and non-conductive material, and is formed by, for example, printing. Examples of the opaque material include materials made opaque by adding a pigment to polymethylmethacrylate, polycarbonate or other light-transmissive resins. Here, when the coating layer 23 is made to have the same color as that of the decorative layer 41, it becomes difficult to discriminate between the decorative layer 41 and the coating layer, even in a case where a user of the sensor panel 10 views the lower portion of the decorative layer 41 obliquely from the operation region 12, that is, at a certain angle to the Z direction, thereby not damaging designability, which leads to a preferable result. Further, when the coating layer 23 is formed of the same material as that of the decorative layer 41, it becomes difficult to discriminate between the decorative layer 41 and the coating layer in appearance by the texture of the coating layer being made common with that of the decorative layer 41. Therefore, even when a user of the sensor panel 10 views the lower portion of the decorative layer 41 obliquely from the operation region 12, the two of them are not likely to be recognized, and thus designability is not damaged.

It is preferable that the coating layer 23 is formed so as to cover all of the plurality of wiring layers 22, but a configuration may be used in which only the wiring layers 22 in a visible range, when viewed obliquely from the operation region 12, are covered. In addition, as shown in FIG. 2, a configuration may be used in which the coating layer 23 is formed so as to protrude from the upper surface of the wiring layer 22 to the inner side thereof, that is, to the transparent electrode layer 21 side, and thereby, the wiring layer 22 is not visible when viewed obliquely from the operation region 12. In this case, the coating layer 23 may not be formed on the lateral side of the wiring layer 22.

In addition, it is preferable that the coating layer 23 is formed on the XY plane in a range which does not exceed a range in which the decorative layer 41 is projected onto the substrate 20 in the Z direction. Thereby, when a user views the sensor panel 10 from the operation region 12 in a direction along the Z direction, the coating layer 23 is not recognized, which leads to a preferable result in view of design.

Further, it is preferable that the coating layer 23 has such a shape as that in which the plurality of wiring layers 22 are collectively covered without being provided for each of the wiring layers 22, and is formed in a shape corresponding to a shape in which the decorative layer 41 is projected onto the substrate 20 in the Z direction. When the coating layer 23 is formed for each of the wiring layers 22, the planar shape of the coating layer 23 has irregularities in the X direction and/or Y direction, and thus discrimination between the decorative layer 41 and the coating layer is facilitated. However, the formation of the coating layer in a shape corresponding to the decorative layer 41 causes difficulty in discriminating between the decorative layer 41 and the coating layer when viewed from the panel surface 11 side, and thus fixed designability can be maintained.

The adhesive layer 24 is formed by printing so as to cover the transparent electrode layer 21, the wiring layer 22, and the coating layer 23. The adhesive layer 24 is formed of, for example, an ultraviolet curable or thermosetting optically transparent adhesive.

The cover layer 30 is formed of a light-transmissive and flexible resin, for example, polymethylmethacrylate or polycarbonate, and is provided between the adhesive layer 24 and the resin layer 40 by molding or printing. The cover layer 30 is fixed to the transparent electrode layers 21, the wiring layer 22, and the coating layer 23 by the adhesive layer 24.

The resin layer 40 is constituted by the decorative layer 41 and the light-transmissive layer 42, has flexible properties, and is formed by, for example printing. The decorative layer 41 constituting the decorative region 13 is formed of an opaque and non-conductive material, and examples of the material include materials made opaque by adding a pigment to polymethylmethacrylate, polycarbonate or other light-transmissive resins. The light-transmissive layer 42 constituting the operation region 12 is formed in an inside region surrounded by the decorative layer 41, and is formed of a light-transmissive and non-conductive resin, for example, polymethylmethacrylate, polycarbonate or other resins. The decorative layer 41 is formed to be located above the wiring layers 22 so as to correspond to the plurality of wiring layers 22, and the light-transmissive layer 42 is formed to be located above the transparent electrode layers 21 so as to correspond to the plurality of transparent electrode layers 21.

Meanwhile, a surface coating layer may be provided outside of the resin layer 40. The surface coating layer has flexible and light-transmissive properties, and is formed of a non-conductive material, for example, polymethylmethacrylate, polycarbonate or other resins.

With the above configuration, light can be transmitted along the Z direction from the lower portion of the substrate 20 through the transparent electrode layer 21, the cover layer 30, and the light-transmissive layer 42, and a range corresponding to the light-transmissive layer 42 is set as the operation region 12 on the panel surface 11. On the other hand, in a range corresponding to the decorative region 13 on the panel surface 11, when viewed from a direction along the Z direction, the plurality of wiring layers 22 is covered with the decorative region 13 and is not able to be visually recognized. In addition, the coating layer 23 is provided on the wiring layer 22. Therefore, when a user of the sensor panel 10 views the lower portion of the decorative layer 41 obliquely from the operation region 12, an optical path from the operation region 12 to the wiring layer 22 is blocked by the coating layer 23, and thus the wiring layer 22 is not able to be visually recognized.

### (2) Method of Manufacturing Sensor Panel 10

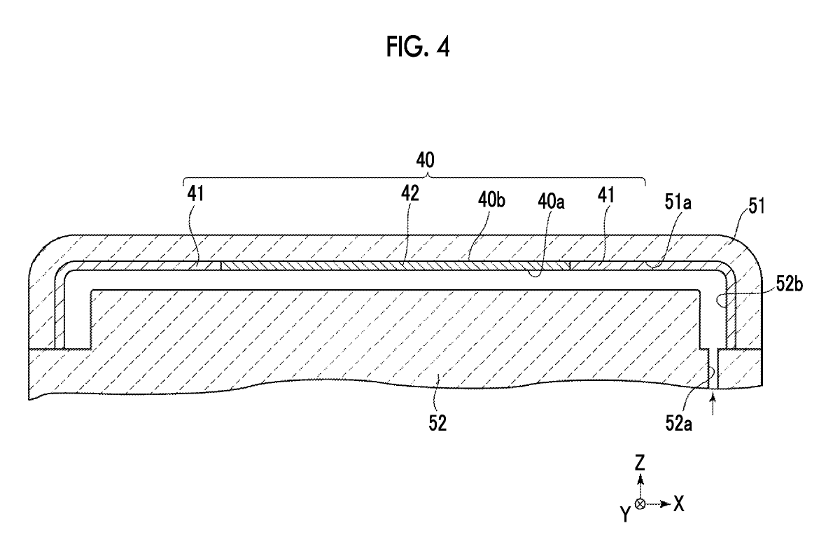

FIG. 4 is a diagram illustrating a process of forming the cover layer 30, and is a cross-sectional view corresponding to FIG. 2. The sensor panel 10 is manufactured by the following processes (A) to (E).

(A) The transparent electrode layer 21 and the wiring layer 22 are formed on the substrate 20. The transparent electrode layer 21 is formed in a predetermined pattern by, for example ITO sputtering, and the wiring layer 22 is formed in a predetermined pattern in the vicinity of the transparent electrode layer 21 by, for example, copper sputtering.

(B) The coating layer 23 is formed on the wiring layer 22 which is formed on the substrate 20 in the process (A). The coating layer 23 is formed by printing ink obtained by melting an opaque material in a solvent and drying and solidifying the melted material through heating.

(C) The resin layer 40 is formed on a base member such as glass by printing. In the formation of the resin layer 40, the decorative layer 41 is formed by printing decorative layer ink obtained by melting an opaque and non-conductive material in a solvent, and the light-transmissive layer 42 is formed by printing light-transmissive layer ink obtained by melting a light-transmissive and non-conductive resin in a solvent. The decorative layer 41 and the light-transmissive layer 42 are dried and solidified by heating, and are peeled off from the base member, as an integrally formed film. In order to peel off the resin layer 40 from the base member, it is preferable that a peeling agent is applied onto the base member before the printing of the decorative layer 41 and the light-transmissive layer 42.

(D) The cover layer 30 is formed using a first mold 51 and a second mold 52 shown in FIG. 4. First, an upper surface 40b of the film-like resin layer 40 formed in the process (C) is disposed along an inner surface 51a of the first mold 51. Next, a light-transmissive resin is filled into a cavity 52b surrounded by the resin layer 40 within the first mold 51 and the second mold 52 from a gate 52a of the second mold 52, and is cooled and solidified in predetermined pressure and temperature conditions. Thereby, the light-transmissive cover layer 30 is formed along a lower surface 40a of the resin layer 40.

(E) The adhesive layer 24 is formed by applying an optically transparent adhesive onto the substrate 20 through printing so as to cover the transparent electrode layer 21 and the wiring layer 22 which are formed in the process (A) and the coating layer 23 which is formed in the process (B). Next, the cover layer 30 fixed to the resin layer 40 in the process (D) is disposed on the adhesive layer 24. In this case, the decorative layer 41 is disposed above the plurality of wiring layers 22, and the light-transmissive layer 42 is disposed above the plurality of transparent electrode layers 21. Further, the adhesive layer 24 is cured by irradiation with ultraviolet rays. Thereby, the sensor panel 10 is completed in which the substrate 20, the transparent electrode layers 21, the wiring layer 22, the coating layer 23, the adhesive layer 24, the cover layer 30, and the resin layer 40 are formed to be integrated with each other.

With such a configuration, according to the embodiment, the following effects are exhibited.

(1) In the sensor panel 10 of the first embodiment, even when the wiring layer 22 side located below the decorative layer 41 is viewed obliquely from the operation region 12 side of the panel surface 11, the wiring layer 22 is hidden by the coating layer 23, and thus it is possible to prevent designability from deteriorating due to a colored wiring layer 22 being visible. In addition, even when the decorative region 13 is made narrower, it is possible to secure a region in which the wiring layer 22 is formed, and to prevent the wiring layer 22 from being visually recognized when viewed obliquely from the operation region 12.

(2) It is possible to hide the wiring layer 22 by the coating layer 23, even when the wiring layer 22 side located below the decorative layer 41 is viewed obliquely from the operation region 12 side of the panel surface 11, just by adding a simple process such as printing of the coating layer 23.

### Second Embodiment

Subsequently, a second embodiment of the present invention will be described. In a sensor panel 110 of the second embodiment, a portion of a cover layer 130 is used as a shielding layer 131 instead of the coating layer 23 of the first embodiment, and thus it is possible to prevent the wiring layer 22 from being visually recognized from an operation region 112. In the following description, the same members as those in the first embodiment are denoted by the same reference numerals and signs, and thus the detailed description thereof will not be given.

### (1) Configuration of Sensor Panel 110

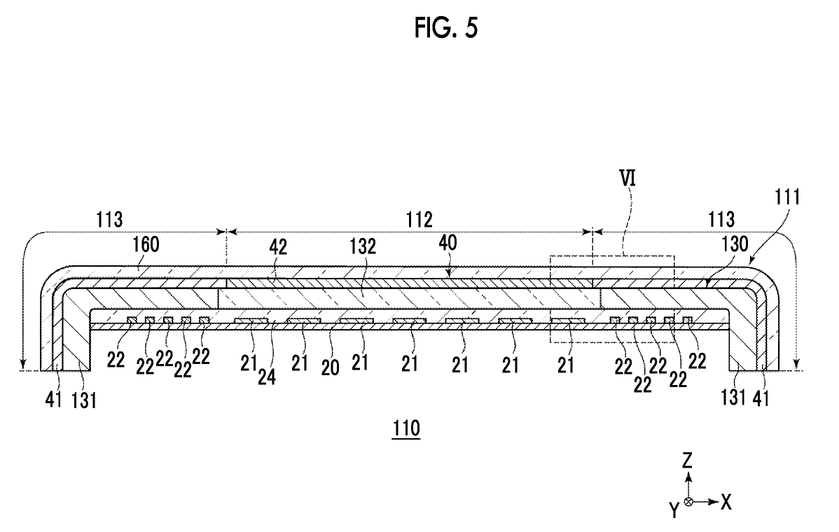

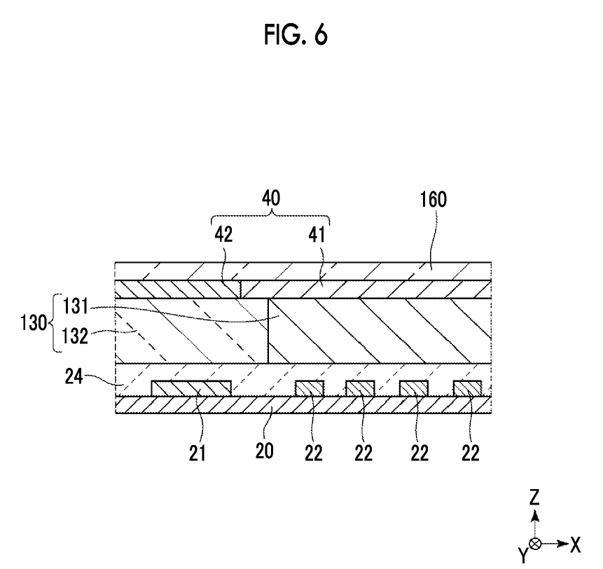

FIG. 5 is a cross-sectional view of the sensor panel 110 in the Z direction, and is a cross-sectional view corresponding to FIG. 2. FIG. 6 is an enlarged view illustrating a portion VI of FIG. 5.

The sensor panel 110 includes the same outward shape as that of the sensor panel 10 shown in FIG. 1, and includes the operation region 112 and a decorative region 113 on a panel surface 111, similarly to the panel surface 11, the operation region 12, and the decorative region 13 of the first embodiment. As shown in FIG. 5 or 6, the sensor panel 110 includes the substrate 20, the transparent electrode layers 21, the wiring layers 22, the adhesive layer 24, the cover layer 130, the resin layer 40, and a surface coating layer 160.

The cover layer 130 is constituted by the shielding layer 131 and a light-transmissive layer 132, has flexible properties, and is provided between the adhesive layer 24 and the resin layer 40 by two-color molding or printing.

The shielding layer 131 is formed of an opaque and non-conductive material in a peripheral region of the cover layer 130 facing the decorative layer 41, and examples of the material include materials made opaque by adding a pigment to polymethylmethacrylate, polycarbonate or other light-transmissive resins. The light-transmissive layer 132 is formed in an inside region surrounded by the shielding layer 131, and is formed of a light-transmissive and non-conductive resin, for example, polymethylmethacrylate, polycarbonate or other resins. The shielding layer 131 is formed so as to face a plurality of wiring layers 22 and to be located above the wiring layers 22. In addition, the light-transmissive layer 132 is formed so as to face a plurality of transparent electrode layers 21 and to be located above the transparent electrode layers 21.

Here, it is preferable that the shielding layer 131 is formed of the same color and material as those of the decorative layer 41, due to the same reason as that in the coating layer 23 of the first embodiment. In addition, it is preferable that the shielding layer 131 is formed so as to cover all the upper portions of the plurality of wiring layers 22, but a configuration may be used in which the upper portions of only the wiring layers 22 in a visible range when viewed obliquely from the operation region 112 are covered. Further, the shielding layer 131 is formed on the XY plane in a range which does not exceed a range in which the decorative layer 41 is projected onto the substrate 20 in the Z direction. Thereby, when a user views the sensor panel 110 from the operation region 112 in a direction along the Z direction, the shielding layer 131 is not recognized, which leads to a preferable result in view of design.

The surface coating layer 160 has flexible and light-transmissive properties, and is formed of a non-conductive material, for example, polymethylmethacrylate, polycarbonate or other resins. The surface coating layer 160 is used as, for example, a base member for forming the resin layer 40. Meanwhile, a configuration may be used in which the resin layer 40 is used as the outermost layer without providing the surface coating layer 160, and the surface of the resin layer 40 serves as the panel surface 111 of the sensor panel 110.

### (2) Method of Manufacturing Sensor Panel 110

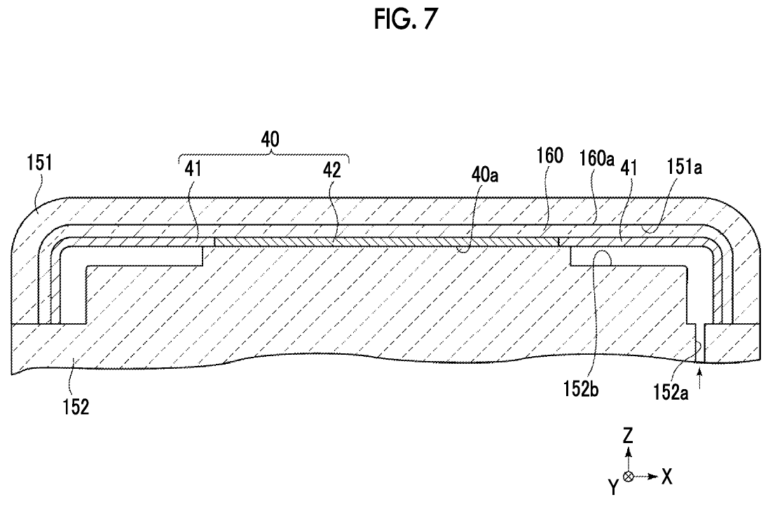

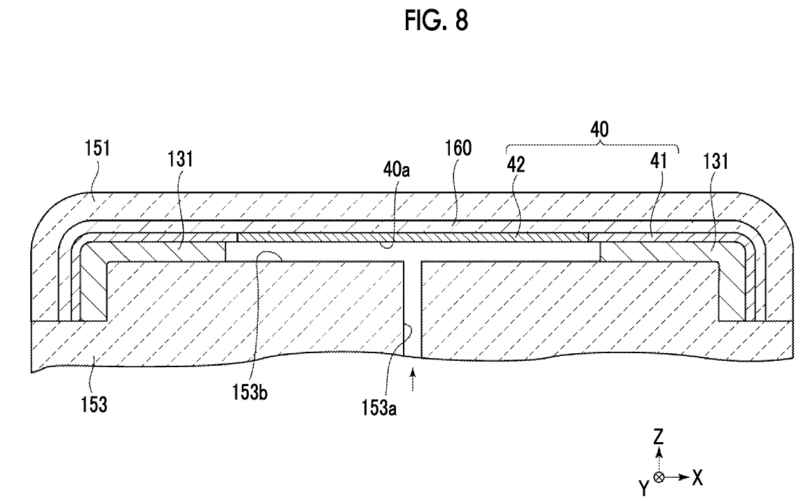

FIG. 7 is a diagram illustrating a process of forming the shielding layer 131, and FIG. 8 is a diagram illustrating a process of forming the light-transmissive layer 132. FIGS. 7 and 8 are cross-sectional views corresponding to FIG. 5. The sensor panel 110 is manufactured by the following processes (F) to (J).

(F) Similarly to the process (A) of the first embodiment, the transparent electrode layer 21 and wiring layer 22 are formed on the substrate 20. The transparent electrode layer 21 is formed by, for example, ITO sputtering, and the wiring layer 22 is formed in the vicinity of the transparent electrode layer 21 by, for example, copper sputtering.

(G) The resin layer 40 is formed on the surface coating layer 160 by printing. In the formation of the resin layer 40, the decorative layer 41 is formed by printing decorative layer ink obtained by melting an opaque and non-conductive material in a solvent, and the light-transmissive layer 42 is formed by printing light-transmissive layer ink obtained by melting a light-transmissive and non-conductive resin in a solvent. The decorative layer 41, the light-transmissive layer 42, and the surface coating layer 160 are dried and solidified by heating, and are formed as an integral film.

(H) The shielding layer 131 is formed using a first mold 151 and a second mold 152 as a shielding layer forming mold which are shown in FIG. 7. First, the resin layer 40 and the surface coating layer 160 which are formed in an integral film shape in the process (G) are disposed within the first mold 51. Specifically, the resin layer 40 and the surface coating layer 160 are disposed so that an upper surface 160a of the surface coating layer 160 is along an inner surface 151a of the first mold 151. Next, a non-light-transmissive resin is filled into a cavity 152b surrounded by the resin layer 40 within the first mold 151 and the second mold 152 from a gate 152a of the second mold 152, and is cooled and solidified in predetermined pressure and temperature conditions. Thereby, the opaque shielding layer 131 is formed along the lower surface 40a of the resin layer 40.

(I) The light-transmissive layer 132 is formed using the first mold 151 and a third mold 153 as a light-transmissive layer forming mold which are shown in FIG. 8. The first mold 151 is a common mold with the process (H). After the shielding layer 131 is formed in the process (H), the second mold 152 is replaced by the third mold 153, and a light-transmissive resin is filled into a cavity 153b surrounded by the resin layer 40 and the shielding layer 131 within the first mold 151 and the third mold 153, from a gate 153a of the third mold 153, and is cooled and solidified in predetermined pressure and temperature conditions. Thereby, the light-transmissive light-transmissive layer 132 is formed in a region corresponding to the operation region 112, along the lower surface 40a of the resin layer 40 and in a shape surrounded by the shielding layer 131.

(J) The adhesive layer 24 is formed by applying an optically transparent adhesive onto the substrate 20 through printing so as to cover the transparent electrode layers 21 and the wiring layer 22 which are formed in the process (F). Next, the cover layer 130 which is formed in the processes (H) and (I) is disposed on the adhesive layer 24. In this case, the decorative layer 41 is disposed above the plurality of wiring layers 22, and the light-transmissive layer 42 is disposed above the plurality of transparent electrode layers 21. Further, the adhesive layer 24 is cured by irradiation with ultraviolet rays. Thereby, the sensor panel 110 is completed in which the substrate 20, the transparent electrode layers 21, the wiring layer 22, the adhesive layer 24, the cover layer 130, the resin layer 40, and the surface coating layer 160 are formed to be integrated with each other.

According to the sensor panel 110 configured and manufactured as described above, even when the wiring layer 22 side located below the decorative layer 41 is viewed obliquely from the operation region 112 side of the panel surface 111, the wiring layer 22 can be hidden by the shielding layer 131. In addition, even when the decorative region 113 is made narrower, it is possible to secure a region in which the wiring layer 22 is formed, and to prevent the wiring layer 22 from being visually recognized when viewed obliquely from the operation region 112. In addition, since the shielding layer 131 and the light-transmissive layer 132 are formed using a common mold, it is possible to suppress manufacturing costs, and to obtain a visual recognition preventing effect of the wiring layer 22.

Meanwhile, other operations, effects, and modification examples are the same as those in the first embodiment.

Although the present invention has been described with reference to the embodiments, the present invention is not limited to the embodiments, and can be modified or changed within an object for improvement or the scope of the present invention.

As described above, the sensor panel according to the present invention is useful in a panel having a colored wiring layer, and is particularly more useful as an interval between the decorative layer and the substrate becomes larger.

It should be understood by those skilled in the art that various modifications, combinations, sub-combinations and alterations may occur depending on design requirements and other factors insofar as they are within the scope of the appended claims of the equivalents thereof.

1. A sensor panel having an operation region, the sensor panel comprising:
a transparent substrate;
a transparent electrode layer formed on the substrate in the operation region;
a wiring layer formed on the substrate so as to surround the transparent electrode layer;
an opaque decorative layer facing the wiring layer;
a cover layer provided between the substrate and the decorative layer, the cover layer being transparent at least in an area corresponding to the operation region; and
a shielding layer provided between the wiring layer and the decorative layer so as to obstruct an optical path from the operation region to the wiring layer.

2. The sensor panel according to claim 1, wherein the shielding layer is an opaque coating layer formed on the wiring layer.

3. The sensor panel according to claim 1, wherein the shielding layer is formed as a peripheral region of the cover layer facing the decorative layer, the peripheral region being opaque.

4. The sensor panel according to claim 1, wherein the shielding layer and the decorative layer have a same color.

5. The sensor panel according to claim 4, wherein the shielding layer and the decorative layer are formed of a same material.

6. A method of manufacturing a sensor panel having an operation region, the method comprising:
forming a transparent electrode on a transparent substrate in the operation region;
forming a wiring layer on the substrate so as to surround the transparent electrode layer;
forming a shielding layer by printing an opaque coating layer on the wiring layer;
providing a cover layer made of a transparent resin and having an opaque decorative layer formed on a peripheral region of an upper surface thereof; and
laving the cover layer having the decorative layer provided thereon over the substrate having the transparent electrode, the wiring layer, and the shielding layer provided thereon, such that a lower side of the decorative layer faces the shielding layer with the cover layer interposed therebetween.

7. A method of manufacturing a sensor panel having an operation region, the method comprising:
forming a transparent electrode on a transparent substrate in the operation region;
forming a wiring layer on the substrate so as to surround the transparent electrode layer;
providing a cover layer, including:
providing a resin layer having a light-transmissive portion and an opaque decorative portion, the light-transmissive portion corresponding to the operation region;
disposing the resin layer within a mold;
injecting an opaque resin into the mold on the resin layer using a first injection mold, thereby forming an opaque shielding layer in a region corresponding to the decorative portion; and
injecting a transparent resin into the mold on the resin layer using a second injection mold, thereby forming a light-transmissive layer in an inner region of the shielding layer, the light-transmissive layer corresponding to the operation region; and
mounting the cover layer formed of the shielding layer and the light-transmissive layer and having the resin layer provided thereon over the substrate having the transparent electrode and the wiring layer provided thereon, such that a lower side of the decorative portion of the resin layer faces and covers the wiring layer with the shielding layer interposed therebetween.

8. The method of manufacturing a sensor panel according to claim 7, wherein the providing the resin layer includes:
providing a transparent coating layer; and
printing the opaque decorative portion and the light-transmissive portion on the transparent coating layer.
